(19) United States
(12) Patent Application Publication
(10) Pub. No.: US 2026/0323478 A1
(43) Pub. Date: Oct. 15, 2026

(54) METHOD AND APPARATUS FOR ACCESS MANAGEMENT IN WIRELESS COMMUNICATION SYSTEM

(71) Applicant: SAMSUNG ELECTRONICS CO., LTD., Suwon-si, Gyeonggi-do (KR)

(72) Inventor: Kyungjoo SUH, Suwon-si (KR)

(21) Appl. No.: 19/117,338

(22) PCT Filed: Sep. 27, 2023
(86) PCT No.: PCT/KR2023/014949

§ 371 Date: Mar. 31, 2025

(30) Foreign Application Priority Data
Sep. 30, 2022 (KR) 10-2022-0125863
Oct. 4, 2022 (KR) 10-2022-0126624

(51) Int. Cl. H04W 48/02; H04W 48/16; H04W 76/10

(52) U.S. Cl. CPC H04W 48/02; H04W 48/16; H04W 76/10

(57) ABSTRACT

The present disclosure relates to a 5G or 6G communication system for supporting a higher data transmission rate. An operating method of a UE in a mobile communication system, according to the present disclosure, may comprise the steps of: receiving, from a base station via a system information block (SIB), information regarding an access category including an operator defined access category; and on the basis of the information regarding the access category; determining whether or not access is barred for each protocol data unit (PDU) session from among a plurality of PDU sessions including a PDU session corresponding to the operator defined access category.

### TECHNICAL FIELD

The disclosure relates to a method and device for access management in a mobile communication system, and more specifically, to a method and device for access management using non-access stratum (NAS) and/or access stratum (AS) protocols.

### BACKGROUND ART

5G mobile communication technologies define broad frequency bands to enable high transmission rates and new services, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure provides a method and device for access management using non-access stratum (NAS) and/or access stratum (AS) protocols.

### Solution to Problem

An operating method of a UE in a mobile communication system according to an embodiment may include receiving, from a base station, information on an access category through a system information block (SIB), and determining whether access is barred for each PDU session based on the information on the access category when a plurality of PDU sessions including a first packet data unit (PDU) session corresponding to an operator-defined access category are established.

An operating method of a base station in a mobile communication system according to an embodiment may include transmitting, to a UE, information on the access category through a system information block (SIB). The information on the access category may be for determining whether access is barred for each PDU session when a plurality of PDU sessions including a first packet data unit (PDU) session corresponding to the operator-defined access category are established.

A UE in a mobile communication system according to an embodiment may include a transceiver; a memory; and at least one processor connected to the transceiver and the memory. The at least one processor may be controlled to receive, from a base station, information on an access category through a system information block (SIB), and determine whether access is barred for each PDU session based on the information on the access category when a plurality of PDU sessions including a first packet data unit (PDU) session corresponding to an operator-defined access category are established.

A base station in a mobile communication system according to an embodiment may include a transceiver; a memory; and at least one processor connected to the transceiver and the memory. The at least one processor may be controlled to transmit, to a UE, information on the access category through a system information block (SIB), and the information on the access category may be to determine whether access is barred for each PDU session when a plurality of PDU sessions including a first packet data unit (PDU) session corresponding to the operator-defined access category are established.

### Advantageous Effects of Invention

According to the disclosure, services may be provided effectively.

### BRIEF DESCRIPTION OF DRAWINGS

FIG. 1 is a diagram illustrating an example of an environment for allowing or controlling UE access in a 5G network according to an embodiment of the disclosure.

FIG. 2 is a diagram illustrating a procedure for allowing or controlling UE access in a 5G network environment according to an embodiment of the disclosure.

FIG. 3 is a diagram illustrating a procedure for allowing or controlling UE access in a 5G network environment according to another embodiment of the disclosure.

FIG. 4 illustrates a structure of a UE according to an embodiment of the disclosure.

FIG. 5 illustrates a structure of a network entity according to an embodiment of the disclosure.

FIG. 6 is a diagram illustrating a procedure for allowing or controlling UE access in a 5G network environment according to another embodiment of the disclosure.

FIG. 7 is a diagram illustrating a procedure for allowing or controlling UE access in a 5G network environment according to another embodiment of the disclosure.

FIG. 8 is a diagram illustrating a procedure for allowing or controlling UE access in a 5G network environment according to an embodiment of the disclosure.

### MODE FOR THE INVENTION

Hereinafter, exemplary embodiments of the disclosure will be described in detail with reference to the accompanying drawings. It should be noted that, in the accompanying drawings, the same or like elements are designated by the same or like reference signs as much as possible. Also, a detailed description of known functions or configurations that may make the subject matter of the disclosure unnecessarily unclear will be omitted.

In describing the embodiments in the specification, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms, and the embodiments of the disclosure are provided merely to completely disclose the disclosure and inform those skilled in the art of the scope of the disclosure. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in the standards for 5G and LTE systems are used for the sake of descriptive convenience. However, the disclosure is not limited by these terms and names, and may be applied in the same way to systems that conform other standards.

That is, the following detailed description of embodiments of the disclosure is directed to communication standards specified by 3GPP, but based on determinations by those skilled in the art, the main idea of the disclosure may also be applied to other communication systems having similar technical backgrounds through some modifications without significantly departing from the scope of the disclosure.

The disclosure provides a method for managing UE access for communication in a 5G communication system, a method for controlling access, or a device performing these functions.

In particular, according to an embodiment of the disclosure, when performing communication, communication may be performed without restricting (barring) access for communication. Access control is intended to facilitate communication in a congestion situation. This access control technology is a technology for controlling or allowing UE access and providing a service in an environment in which multiple UEs perform access, for example, an environment in which a number of UEs perform access in an emergency situation, an earthquake, a tsunami, etc., or in an environment in which an event-related service occurs because multiple UEs are clustered together, for example, an environment in which an event-related service traffic or a multimedia streaming service occurs in a situation where spectators are gathered at a music event or a large sports stadium.

According to the unified access control of the 5G system, access control may be performed by using an access category defined by a standard or an access category defined by a business operator. However, when using the access category defined by a business operator, there may be a case where another communication is interrupted or another communication becomes impossible. Various embodiments of the disclosure provide a method and device capable of solving this problem.

In the 5G mobile communication system, the AMF, which is the management entity that manages the mobility of the UE, and the SMF, which is the entity that manages the session, are separated. Accordingly, unlike the existing 4G LTE communication operation method in which the MME manages the mobility and session together, the entity that manages the mobility and the entity that manages the session are separated, so the communication method and communication management method between the UE and the network entity have changed.

With the advent of 5G communication, via N3 interworking function (N3IWF) for non-3GPP access, mobility management is performed through the access and mobility management function (AMF), and session management is performed through the session management function (SMF). In addition, the AMF may perform mobility management and may also process security-related information, which is an important element in mobility management.

Meanwhile, in the 4G system, the mobility management entity (MME) is responsible for mobility management, session management, and management thereof. In the 5G system, there are entities for communication between the 4G system and 5G system. In other words, 5G communication may be performed even in the case of non-standalone architecture by using some 4G communication entities.

According to an embodiment of the disclosure, in the 5G system, NAS and AS protocols may be used to control UE access or allow UE access, thereby controlling UE communication. Accordingly, a smooth communication service may be provided, and data communication may be efficiently performed.

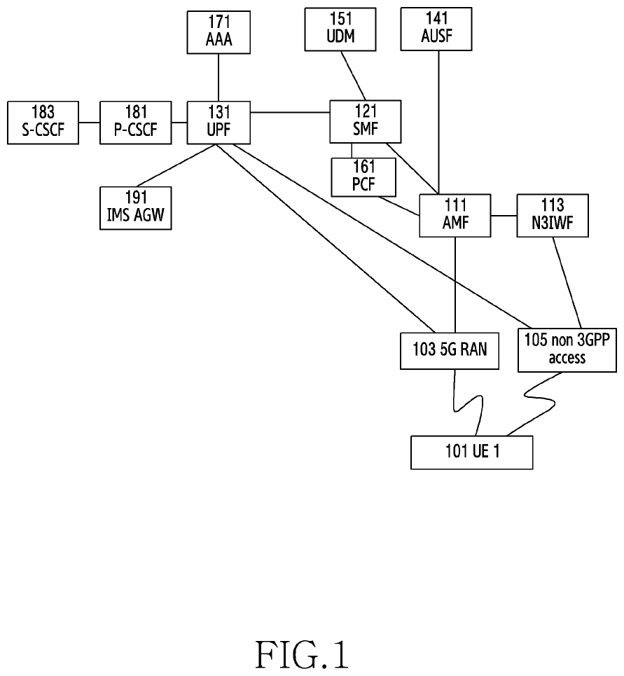

FIG. 1 is a diagram illustrating an example of an environment for allowing or controlling UE access in a 5G network according to an embodiment of the disclosure.

Referring to FIG. 1, the 5G or NR core network may be composed of network functions (NFs) such as an access and mobility management function (AMF) 111, a session management function (SMF) 121, a user plane function (UPF) 131, a user data management (UDM) 151, a policy control function (PCF) 161, etc. In addition, for authentication of these entities, the 5G or NR core network may include entities such as an authentication server function (AUSF) 141, authentication, authorization and accounting (AAA) 171, etc. A user equipment (UE, terminal) 101 may access the 5G core network through a base station (5G radio access network (RAN), base station (BS)) 103. In addition, for the case in which the user equipment (UE) 101 communicates through non-3GPP access 105, an N3 interworking function (N3IWF) 113 may exist, and in the case of communicating through the non-3GPP access 105, session management may be controlled through the UE 101, non 3GPP access 105, N3IWF 103, and SMF 121, and mobility management may be controlled through the UE 101, non 3GPP access 105, N3IWF 113, and AMF 111.

In the 5G or NR system, entities performing mobility management and session management are separated into AMF 111 and SMF 121. Meanwhile, a standalone deployment structure that performs communication only with 5G or NR entities and a non-standalone deployment structure that uses 4G entities and 5G or NR entities together are being considered for the 5G or NR system.

Meanwhile, for multi-media telephony (MMTEL) voice, MMTEL video, and short message service (SMS) over IMS services through IP multimedia subsystem (IMS), there may be a proxy call state control function (P-CSCF) and a serving call state control function (S-CSCF) to control IMS message signaling. In addition, there may be an IMS AGW (gateway) for IMS services to perform multimedia communication.

Although the communication network described in the disclosure describes a 5G or NR system or a 4G LTE system as an example, the content of the disclosure may be applied when the same concept is applied to another communication system within the scope understood by those with ordinary technology.

When the UE 101 performs data communication, there may be multiple PDU sessions established by the UE 101 with the network. If there is an operator-defined access category among these PDU sessions, access to the network may be completely restricted due to the operator-defined access category. The disclosure provides a method and device for solving this problem.

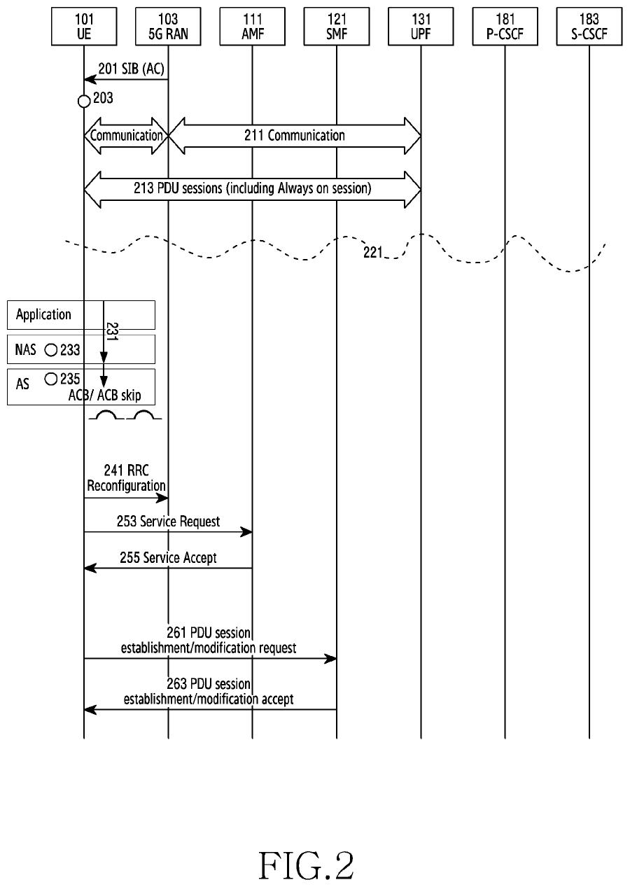

FIG. 2 is a diagram illustrating a procedure for allowing or controlling UE access in a 5G network environment according to an embodiment of the disclosure.

Referring to FIG. 2, in process 201, the UE 101 may receive information on an access category from the 5G RAN 103 gNB. For example, the UE 101 may receive information on the access category from the gNB through broadcast information by using SIB1. Meanwhile, SIB 1 is only an example, and is not limited thereto, and information on the access category may be received through another SIB.

In process 203, the UE 101 may store information on the received access category. In this case, the information on the received access category may include information such as barring factor, access category, and barring time related to the access category. The barring-related information may be explicitly transmitted, or implicitly transmitted as information including a barring factor already defined and an identifier of barring-related information.

In process 211, the UE 101 may communicate with the UPF 131 through the 5G RAN 103.

As illustrated in process 213, in the process in which the UE 101 communicates with the UPF 131 through the 5G RAN 101, multiple PDU sessions may be established and communication may be performed.

Among the PDU sessions, there may be a PDU session belonging to the operator-defined access category. In addition, an always-on PDU session may be included among the PDU sessions. In addition, among the PDU sessions, there may be a PDU session that is the always-on PDU session and belongs to the operator-defined access category. Meanwhile, if a PDU session that is the always-on PDU session and belongs to the operator-defined access category is included among the PDU sessions, the following phenomenon may occur. That is, if the UE 101 changes from an idle mode to a connected mode, if the UE 101 changes from a radio resource control (RRC) inactive mode to an RRC connected mode, or if the RRC connection of the UE 101 is released and changes to a connected mode, access to the network of the UE 101 may be barred.

In process 213, it is assumed that multiple PDU sessions include PDU session 1, PDU session 2, and PDU session 3. Among them, it is assumed that PDU session 2 is the always-on PDU session and the operator-defined access category 32. Meanwhile, the operator-defined access category may be used from 32 to 63, and is a category used when access is to be controlled and/or allowed by each operator.

As illustrated in process 221, for some reason, if the UE 101 changes to an idle mode, if the UE 101 is in an RRC inactive mode, or if the RRC connection of the UE 101 is released, a process is required to change the UE 101 back to the RRC connected state. In this process, there may be a case in which the UE 101's access to the network is barred.

Subsequent processes 231, 233, and 235 are processes that occur inside the UE 101.

In process 231, the application layer of the UE 101, for example, the upper layer in charge of the application, may transmit a signal to the NAS layer to trigger the application. Specifically, the initiation of the application layer service may be triggered.

In process 233, the NAS layer of the UE 101 may map the access attempt type and the access category transmitted from the upper layer (e.g., the application layer) and transmit them to the AS layer. Alternatively, the NAS layer of the UE 101 may map the access attempt type and the access category according to the signaling indication transmitted from the upper layer (e.g., the application layer) and transmit the corresponding access category, access attempt type, etc. to the AS layer.

According to an embodiment, the NAS layer may transmit an access category corresponding to an application-related signal, a mobile originate signal, and mobile originate data to the AS layer. In this case, one or more access categories may be selected and transmitted to the AS layer. The access category selected in an embodiment may include a standard category and an operator-defined category. When both the standard category and the operator-defined category are selected, the standard category may be selected or the operator-defined category may be selected with priority over the standard category.

As an embodiment, a service may be mapped to the operator-defined access category and the standard access category. Alternatively, as an embodiment, if a service is not mapped to the operator-defined access category, the service may be mapped to one of the standard access categories.

In process 233, the NAS layer maps the access attempt type information and the access category information based on the service triggered in the application layer, and transfers the mapping information, access attempt type, and access category information to the AS layer. The NAS layer may operate as follows when described using PDU session 1, PDU session 2, and PDU session 3 (PDU sessions used as examples in process 213).

The NAS layer may map the access attempt type and access category for each PDU session and transmit the corresponding access category, access attempt type, etc. to the AS layer.

In process 235, the AS layer operates as follows.

Based on the access category information, access baring factor, and access baring time received and stored in process 201, the AS layer performs access barring for the access category corresponding to barring, and access skip for the access category corresponding to barring skip. In order to determine whether to perform access barring or access barring skip, the AS layer refers to the access attempt received from the NAS layer and the mapping information of the access category. In other words, if the access category transmitted by the NAS layer to the AS layer corresponds to access barring, the access is barred, and if the category corresponds to access barring skip, the access barring skip is performed.

According to another embodiment, the AS of the UE derives a rand which is a random value between 0 and 1, and if the derived random value is less than the received barring factor, the access is not prohibited, and if the derived random value is greater than the barring factor, the access is considered prohibited. If the access is prohibited, the UE derives an actual barring time (derived actual barring timer: derived barring time) using the received barring time and random value, and delays the access attempt during the derived barring timer. If the access is prohibited, the AS of the UE notifies the NAS that the access is prohibited, and when the derived barring timer expires, the AS may notify the NAS that “the NAS may request the AS to attempt access again”.

In this case, as assumed above, if the PDU session is a multiple PDU session, the following problems may occur. For example, as explained above, when assuming that PDU session 2 is an always-on PDU session and operator-defined access category 32, access may be barred by the operator-defined access category 32 even though PDU session 2 is the always-on PDU session. On the other hand, PDU session 1 and PDU session 3 may belong to the standard access category and access may be allowed.

According to the prior art, in process 235, access is barred by PDU session 2 out of 3 PDU sessions, so the RRC reconfiguration/configuration/resume/connection setup complete messages in process 241 cannot be transmitted from the UE 101 to the 5G RAN 103, and the service request message in process 251 cannot be transmitted either.

In process 235, the UE 101 operates as follows.

The AS layer may determine whether to bar/allow access of the UE 101 for a corresponding cell, based on access category information related to access class barring and access class barring skip, information such as barring factor, barring timer, etc. received through SIB1 and stored in the UE 101, access attempt type information and access category information received from the NAS layer, and mapping information.

In this process, when there is a PDU session including the operator-defined access category, the AS layer may determine whether to bar access for each PDU session other than the PDU session including the operator-defined access category. In this case, the AS layer may determine whether to bar each PDU session based on access category information related to access barring and access barring skip, information such as barring factor, barring timer, etc. received through SIB1 and stored in the UE 101, access attempt type information and access category information received from the NAS layer, and mapping information, data network name (DNN) related to each PDU session, network slice information related to each PDU session such as network slice selection assistance information (S-NSSAI) (network slice identifier), etc.

For example, if the access class baring (ACB) values received by the UE through SIB1 are 32 and 4, if PDU session 2 is the always-on PDU session, and if access category 7 is mapped to PDU session 1, operator-defined access category 32 is mapped to PDU session 2, and access category 3 is mapped to PDU session 3 in the NAS layer, PDU session 2 with access attempt type 32 is barred in the AS layer, but PDU session 1 with access category 7 and PDU session 3 with access category 3 are not barred, and access of the UE 101 to the corresponding cell is allowed.

In an embodiment, access categories 10 to 31 are currently reserved for use as new standard access categories. Therefore, values from access categories 10 to 31 may be used, and these values may be assigned to the access categories.

For example, if the access class baring (ACB) values received by the UE through SIB1 are 32 and 4, if PDU session 2 is the always-on PDU session, and if access category 7 is mapped to PDU session 1, operator-defined access category 32 is mapped to PDU session 2, and access category 3 is mapped to PDU session 3 in the NAS layer, PDU session 2 with access attempt type 32 is barred in the AS layer, but one of the new access categories 10 to 31 may be assigned to multiple PDU sessions other than the operator default access category such as PDU session 1 with access category 7 and PDU session 3 with access category 3. Accordingly, access to PDU session 1 and PDU session 3 is not barred, and access to the corresponding cell is allowed for the UE 101.

In process 241, the UE 101 may transmit an RRC reconfiguration request (or RRC configuration request) message to the gNB (e.g., 5G NR).

In process 253, the NAS layer of the UE 101 may transmit a service request message to the AMF 111. When transmitting the service request message, the UE 101 may transmit a bit indicating the PDU session as 1 (on state) to the uplink status IE of the always-on PDU session.

In subsequent process 255, in response to the service request message, the service accept message may be transmitted from the AMF 111 to the UE 101.

In process 261, a PDU session establishment request or PDU session modification request message may be transmitted from the UE 101 to the SMF 121.

In subsequent process 263, a PDU session establishment command or PDU session modification command may be transmitted from the SMF 121 to the UE 101.

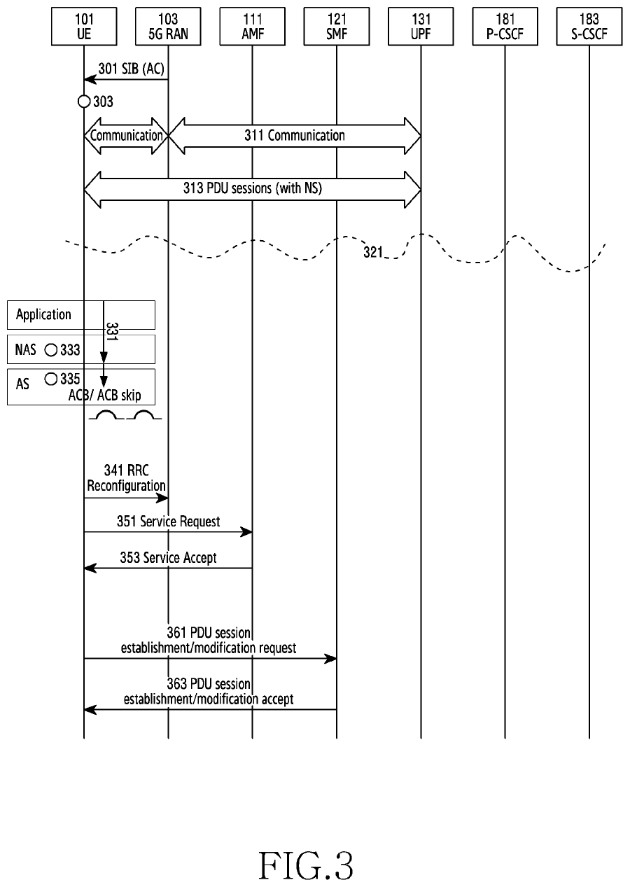

FIG. 3 is a diagram illustrating a procedure for allowing or controlling UE access in a 5G network environment according to another embodiment of the disclosure.

Referring to FIG. 3, in process 301, the UE 101 may receive information on an access category from the 5G RAN 103 gNB. For example, the UE 101 may receive information on the access category from the gNB through broadcast information by using SIB1. Meanwhile, SIB 1 is only an example, and is not limited thereto, and information on the access category may be received through another SIB.

In process 303, the UE 101 may store information on the received access category. In this case, the information on the received access category may include information such as barring factor, access category, and barring time related to the access category. The barring-related information may be explicitly transmitted, or implicitly transmitted as information including a barring factor already defined and an identifier of barring-related information.

In process 311, the UE 101 may communicate with the UPF 131 through the 5G RAN 103.

As illustrated in process 313, in the process in which the UE 101 communicates with the UPF 131 through the 5G RAN 101, multiple PDU sessions may be established and communication may be performed.

Among the PDU sessions, there may be a PDU session belonging to the operator-defined access category. In addition, a PDU session access a specific network slice may be included among the PDU sessions. In addition, among the PDU sessions, there may be a PDU session that is the PDU session access a specific network slice and belongs to the operator-defined access category. Meanwhile, if a PDU session that is the PDU session access a specific network slice and belongs to the operator-defined access category is included among the PDU sessions, the following phenomenon may occur. That is, if the UE 101 changes from an idle mode to a connected mode, if the UE 101 changes from a radio resource control (RRC) inactive mode to an RRC connected mode, or if the RRC connection of the UE 101 is released and changes to a connected mode, access to the network of the UE 101 may be barred.

In process 313, it is assumed that multiple PDU sessions include PDU session 1, PDU session 2, and PDU session 3. Among them, it is assumed that PDU session 2 is the PDU session access a specific network slice and the operator-defined access category 32. Meanwhile, the operator-defined access category may be used from 32 to 63, and is a category used when access is to be controlled and/or allowed by each operator.

As illustrated in process 321, for some reason, if the UE changes to an idle mode, if the UE 101 is in an RRC inactive mode, or if the RRC connection of the UE is released, a process is required to change the UE back to the connected state. In this process, there may be a case in which the UE's access to the network is barred.

Subsequent processes 331, 333, and 335 are processes that occur inside the UE 101.

In process 331, the application layer of the UE 101, for example, the upper layer in charge of the application, may transmit a signal to the NAS layer to trigger the application. Specifically, the initiation of the application layer service may be triggered.

In process 333, the NAS layer of the UE 101 may map the access attempt type and the access category transmitted from the upper layer (e.g., the application layer) and transmit them to the AS layer. Alternatively, the NAS layer of the UE 101 may map the access attempt type and the access category according to the signaling indication transmitted from the upper layer (e.g., the application layer) and transmit the corresponding access category, access attempt type, etc. to the AS layer.

According to an embodiment, the NAS layer may transmit an access category corresponding to an application-related signal, a mobile originate signal, and mobile originate data to the AS layer. In this case, one or more access categories may be selected and transmitted to the AS layer. The access category selected in an embodiment may include a standard category and an operator-defined category. When both the standard category and the operator-defined category are selected, the standard category may be selected or the operator-defined category may be selected with priority over the standard category.

As an embodiment, a service may be mapped to the operator-defined access category and the standard access category. Alternatively, as an embodiment, if a service is not mapped to the operator-defined access category, the service may be mapped to one of the standard access categories.

In process 333, the NAS layer maps the access attempt type information and the access category information based on the service triggered in the application layer, and transfers the mapping information, access attempt type, and access category information to the AS layer. The NAS layer may operate as follows when described using PDU session 1, PDU session 2, and PDU session 3 (PDU sessions used as examples in process 213).

The NAS layer may map the access attempt type and access category for each PDU session and transmit the corresponding access category, access attempt type, etc. to the AS layer.

In process 335, the AS layer operates as follows.

Based on the access category information, access baring factor, and access baring time received and stored in process 301, the AS layer performs access barring for the access category corresponding to barring, and access skip for the access category corresponding to barring skip. In order to determine whether to perform access barring or access barring skip, the AS layer refers to the access attempt received from the NAS layer and the mapping information of the access category. In other words, if the access category transmitted by the NAS layer to the AS layer corresponds to access barring, the access is barred, and if the category corresponds to access barring skip, the access barring skip is performed.

According to another embodiment, the AS of the UE derives a rand which is a random value between 0 and 1, and if the derived random value is less than the received barring factor, the access is not prohibited, and if the derived random value is greater than the barring factor, the access is considered prohibited. If the access is prohibited, the UE derives an actual barring time (derived actual barring timer: derived barring time) using the received barring time and random value, and delays the access attempt during the derived barring timer. If the access is prohibited, the AS of the UE notifies the NAS that the access is prohibited, and when the derived barring timer expires, the AS may notify the NAS that “the NAS may request the AS to attempt access again”.

In this case, as assumed above, if the PDU session is a multiple PDU session, the following problems may occur. For example, as explained above, when assuming that PDU session 2 is a PDU session access a specific network slice and operator-defined access category 32, access may be barred by the operator-defined access category 32 even though PDU session 2 is the PDU session access a specific network slice.

On the other hand, PDU session 1 and PDU session 3 may belong to the standard access category and access may be allowed.

According to the prior art, in process 335, access is barred by PDU session 2 out of 3 PDU sessions, so the RRC reconfiguration/configuration/resume/connection setup complete messages in process 341 cannot be transmitted from the UE 101 to the 5G RAN 103, and the service request message in process 351 cannot be transmitted either.

In process 335, the UE 101 operates as follows.

The AS layer may determine whether to bar/allow access of the UE 101 for a corresponding cell, based on access category information related to access class barring and access class barring skip, information such as barring factor, barring timer, etc. received through SIB1 and stored in the UE 101, access attempt type information and access category information received from the NAS layer, and mapping information.

In this process, when there is a PDU session including the operator-defined access category, the AS layer of the UE may determine whether to bar access for each PDU session other than the PDU session including the operator-defined access category. In this case, the AS layer may determine whether to bar each PDU session based on access category information related to access barring and access barring skip, information such as barring factor, barring timer, etc. received through SIB1 and stored in the UE 101, access attempt type information and access category information received from the NAS layer, and mapping information, data network name (DNN) related to each PDU session, network slice information related to each PDU session such as network slice selection assistance information (S-NSSAI) (network slice identifier), etc.

For example, if the access class baring (ACB) values received by the UE through SIB1 are 32 and 4, if PDU session 2 is the always-on PDU session, and if access category 7 is mapped to PDU session 1, operator-defined access category 32 is mapped to PDU session 2, and access category 3 is mapped to PDU session 3 in the NAS layer, PDU session 2 with access attempt type 32 is barred in the AS layer, but PDU session 1 with access category 7 and PDU session 3 with access category 3 are not barred, and access of the UE 101 to the corresponding cell is allowed.

In an embodiment, access categories 10 to 31 are currently reserved for use as new standard access categories. Therefore, values from access categories 10 to 31 may be used, and these values may be assigned to the access categories.

For example, if the access class baring (ACB) values received by the UE through SIB1 are 32 and 4, if PDU session 2 is the PDU session access a specific network slice, and if access category 7 is mapped to PDU session 1, operator-defined access category 32 is mapped to PDU session 2, and access category 3 is mapped to PDU session 3 in the NAS layer, PDU session 2 with access attempt type 32 is barred in the AS layer, but one of the new access categories 10 to 31 may be assigned to multiple PDU sessions other than the operator default access category such as PDU session 1 with access category 7 and PDU session 3 with access category 3. Accordingly, access to PDU session 1 and PDU session 3 is not barred, and access to the corresponding cell is allowed for the UE 101.

In process 341, the UE 101 may transmit an RRC reconfiguration request (or RRC configuration request) message to the gNB (e.g., 5G NR).

In process 353, the NAS layer of the UE 101 may transmit a service request message to the AMF 111. When transmitting the service request message, the UE 101 may transmit a bit indicating the PDU session as 1 (on state) to the uplink status IE of the always-on PDU session.

In subsequent process 355, in response to the service request message, the service accept message may be transmitted from the AMF 111 to the UE 101.

In process 361, a PDU session establishment request or PDU session modification request message may be transmitted from the UE 101 to the SMF 121.

In subsequent process 363, a PDU session establishment command or PDU session modification command may be transmitted from the SMF 121 to the UE 101.

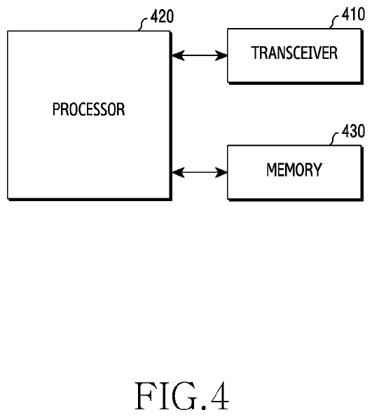

FIG. 4 illustrates a structure of a UE according to an embodiment of the disclosure.

As illustrated in FIG. 4, a UE of the disclosure may include a transceiver 410, a memory 420, and a processor 430. The processor 430, the transceiver 410, and the memory 420 of the UE may operate according to the above-described communication methods of the UE. Components of the UE are not limited to the above-described example. For example, the UE may include a larger or smaller number of components than the above-described components. In addition, the processor 430, the transceiver 410, and the memory 420 may be implemented in the form of a single chip.

The transceiver 410 refers to a UE receiver and a UE transmitter as a whole, and may transmit/receive signals with base stations or network entities. The signals transmitted/received with the base station may include control information and data. To this end, the transceiver 410 may include an RF transmitter configured to up-convert and amplify the frequency of transmitted signals, an RF receiver configured to low-noise-amplify received signals and down-convert the frequency thereof, and the like. However, this is only an embodiment of the transceiver 410, and the components of the transceiver 410 are not limited to the RF transmitter and the RF receiver.

Also, the transceiver 410 may include wired/wireless transceivers, and may include various components for transmitting/receiving signals. In addition, the transceiver 410 may receive signals through a radio channel, output the same to the processor 430, and transmit signals output from the processor 430 through the radio channel. Furthermore, the transceiver 410 may receive communication signals, output same to a processor, and transmit signals output from the processor to a network entity through a wired/wireless network.

In an embodiment, the transceiver 410 may receive SIB 1 including information on access categories.

The memory 420 may store programs and data necessary for operations of the UE. In addition, the storage 420 may store control information or data included in signals acquired by the UE. The memory 420 may include storage media such as a ROM, a RAM, a hard disk, a CD-ROM, and a DVD, or a combination of storage media.

In an embodiment, the memory 420 may store access categories mapped to access attempt types.

The processor 430 may control a series of processes such that the UE can operate according to the above-described embodiments. The processor 430 may include one or more processors. For example, the processor 430 may include a communication processor (CP) which performs control for communication and an application processor (AP) which controls upper layers such as application programs.

In an embodiment, the processor 430 may control the operations according to an embodiment of the disclosure in order to control access barring for communication service-related signals.

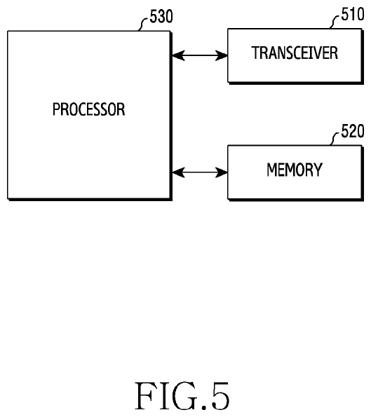

FIG. 5 illustrates a structure of a network entity according to an embodiment of the disclosure.

As illustrated in FIG. 5, a network entity of the disclosure may include a transceiver 510, a memory 520, and a processor 530. The processor 530, the transceiver 510, and the memory 520 of the network entity may operate according to the above-described communication methods of the network entity. However, components of the network entity are not limited to the above-described example. For example, the network entity may include a larger or smaller number of components than the above-described components. In addition, the processor 530, the transceiver 510, and the memory 520 may be implemented in the form of a single chip. The network entity may include network functions (NFs), such as an access and mobility management function (AMF), a session management function (SMF), a policy and charging function (PCF), a network exposure function (NEF), a unified data management (UDM), and a user plane function (UPF), as described above. Also, the network entity may include a base station.

The transceiver 510 refers to a network entity receiver and a network entity transmitter as a whole, and may transmit/receive signals with UEs or other network entities. The transmitted/received signals may include control information and data. To this end, the transceiver 510 may include an RF transmitter configured to up-convert and amplify the frequency of transmitted signals, an RF receiver configured to low-noise-amplify received signals and down-convert the frequency thereof, and the like. However, this is only an embodiment of the transceiver 510, and the components of the transceiver 510 are not limited to the RF transmitter and the RF receiver. The transceiver 510 may include wired/wireless transceivers, and may include various components for transmitting/receiving signals.

In addition, the transceiver 510 may receive signals through a communication channel (e.g., a radio channel), output the same to the processor 530, and transmit signals output from the processor 530 through the communication channel. Furthermore, the transceiver 510 may receive communication signals, output same to a processor, and transmit signals output from the processor to UEs or network entities through a wired/wireless network.

The memory 520 may store programs and data necessary for operations of the network entity. In addition, the memory 520 may store control information or data included in signals transmitted/received by the network entity. The memory 520 may include storage media such as a ROM, a RAM, a hard disk, a CD-ROM, and a DVD, or a combination of storage media.

The processor 530 may control a series of processes such that the network entity can operate according to the above-described embodiments of the disclosure. The processor 530 may include one or more processors.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

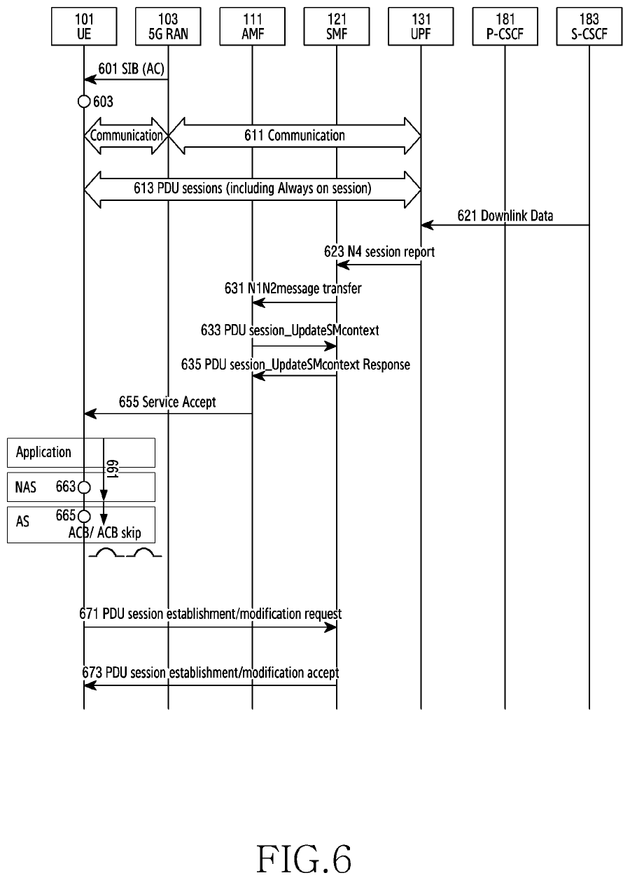

FIG. 6 is a diagram illustrating a procedure for allowing or controlling UE access in a 5G network environment according to an embodiment of the disclosure. FIG. 6 is an embodiment of a case in which the UE is in a CM-connected mode, as may be seen in the processes after process 631.

Referring to FIG. 6, in process 601, the UE 101 may receive information on an access category from the 5G RAN 103 gNB. For example, the UE 101 may receive information on the access category from the gNB through broadcast information by using SIB1. Meanwhile, SIB 1 is only an example, and is not limited thereto, and information on the access category may be received through another SIB.

In process 603, the UE 101 may store information on the received access category. In this case, the information on the received access category may include information such as barring factor, access category, and barring time related to the access category. The barring-related information may be explicitly transmitted, or implicitly transmitted as information including a barring factor already defined and an identifier of barring-related information.

In process 611, the UE 101 may communicate with the UPF 131 through the 5G RAN 103.

As illustrated in process 613, in the process in which the UE 101 communicates with the UPF 131 through the 5G RAN 101, multiple PDU sessions may be established and communication may be performed.

Among the PDU sessions, there may be a PDU session belonging to the operator-defined access category. In addition, an always-on PDU session may be included among the PDU sessions. In addition, among the PDU sessions, there may be a PDU session that is the always-on PDU session and belongs to the operator-defined access category. Meanwhile, if a PDU session that is the always-on PDU session and belongs to the operator-defined access category is included among the PDU sessions, the following phenomenon may occur. That is, if the UE 101 changes from an idle mode to a connected mode, if the UE 101 changes from a radio resource control (RRC) inactive mode to an RRC connected mode, or if the RRC connection of the UE 101 is released and changes to a connected mode, access to the network of the UE 101 may be barred.

In process 613, it is assumed that multiple PDU sessions include PDU session 1, PDU session 2, and PDU session 3. Among them, it is assumed that PDU session 2 is the always-on PDU session and the operator-defined access category 32. Meanwhile, the operator-defined access category may be used from 32 to 63, and is a category used when access is to be controlled and/or allowed by each operator.

In process 621, downlink data is transmitted to the UPF from an external DNN or Internet.

In process 623, the UPF transmits an N4 session report message to the SMF to inform that there is downlink data.

In process 631, the SMF transmits an N1N2 message transfer to the AMF. This message includes UPF tunnel endpoint information and QoS-related information.

In subsequent process after process 633, if the UE is in a CM-connected state, the AMF forwards PDU session-related information received from the SMF to the UE.

In process 633, the AMF transmits a PDU session update SM context message to the SMF. The AMF notifies the SMF that the UE wants to establish a user plane connection.

In process 635, the SMF transmits a PDU session update SM context response message to the AMF. This response message transmits information such as UPF tunnel endpoint identifier or UPF tunnel endpoint IP address.

In process 655, the AMF transmits a service accept message to the UE.

The service request/accept processes may have the following embodiments and conditions.

### Embodiment 1

For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is not in the range 32 to 63, the UE shall include the Uplink data status IE in the SERVICE REQUEST message and indicate that the UE has pending user data to be sent for those PDU sessions.

(For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is not in the range 32 to 63, the UE shall include the Uplink data status IE in the SERVICE REQUEST message and indicate that the UE has pending user data to be sent for those PDU sessions.)

### Embodiment 2

For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include the Uplink data status IE in the SERVICE REQUEST message and indicate that the UE has not pending user data to be sent for those PDU sessions(by marking 0 for bits pointing to the corresponding PDU sessions).

(For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include the Uplink data status IE in the SERVICE REQUEST message and indicate that the UE has not pending user data to be sent for those PDU sessions (by marking 0 for bits pointing to the corresponding PDU sessions).)

### Embodiment 3

For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include in the SERVICE REQUEST message the Uplink data status IE or the always-on PDU IE which indicates that the UE has not pending user data to be sent for those PDU sessions (by marking 0 for bits pointing to the corresponding PDU sessions) but the UE has always-on PDU sessions (by marking 1 for bits pointing to the corresponding PDU sessions).

(For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include in the SERVICE REQUEST message the Uplink data status IE or the always-on PDU IE which indicates that the UE has not pending user data to be sent for those PDU sessions (by marking 0 for bits pointing to the corresponding PDU sessions) but the UE has always-on PDU sessions (by marking 1 for bits pointing to the corresponding PDU sessions).)

### Embodiment 4

For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include in the SERVICE REQUEST message the Uplink data status IE or the always-on PDU IE indicating that the UE has not pending user data to be sent for those PDU sessions but the UE has always-on PDU sessions.

The Uplink data status IE in the SERVICE REQUEST message indicates that the UE has not pending user data to be sent for those PDU sessions (by marking 0 for bits pointing to the corresponding PDU sessions).

The always-on PDU IE in the SERVICE REQUEST message indicates that the UE has always-on PDU sessions (by marking 1 for bits pointing to the corresponding PDU sessions).

(For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include in the SERVICE REQUEST message the Uplink data status IE or the always-on PDU IE indicating that the UE has not pending user data to be sent for those PDU sessions but the UE has always-on PDU sessions.

The Uplink data status IE in the SERVICE REQUEST message indicates that the UE has not pending user data to be sent for those PDU sessions (by marking 0 for bits pointing to the corresponding PDU sessions).

The always-on PDU IE in the SERVICE REQUEST message indicates that the UE has always-on PDU sessions (by marking 1 for bits pointing to the corresponding PDU sessions).)

Subsequent processes 661, 663, and 665 are processes that occur inside the UE 101.

In process 661, the application layer of the UE 101, for example, the upper layer in charge of the application, may transmit a signal to the NAS layer to trigger the application. Specifically, the initiation of the application layer service may be triggered.

In process 663, the NAS layer of the UE 101 may map the access attempt type and the access category transmitted from the upper layer (e.g., the application layer) and transmit them to the AS layer. Alternatively, the NAS layer of the UE 101 may map the access attempt type and the access category according to the signaling indication transmitted from the upper layer (e.g., the application layer) and transmit the corresponding access category, access attempt type, etc. to the AS layer.

According to an embodiment, the NAS layer may transmit an access category corresponding to an application-related signal, a mobile originate signal, and mobile originate data to the AS layer. In this case, one or more access categories may be selected and transmitted to the AS layer. The access category selected in an embodiment may include a standard category and an operator-defined category. When both the standard category and the operator-defined category are selected, the standard category may be selected or the operator-defined category may be selected with priority over the standard category.

As an embodiment, a service may be mapped to the operator-defined access category and the standard access category. Alternatively, as an embodiment, if a service is not mapped to the operator-defined access category, the service may be mapped to one of the standard access categories.

In process 663, the NAS layer maps the access attempt type information and the access category information based on the service triggered in the application layer, and transfers the mapping information, access attempt type, and access category information to the AS layer. The NAS layer may operate as follows when described using PDU session 1, PDU session 2, and PDU session 3 (PDU sessions used as examples in previous processes).

The NAS layer may map the access attempt type and access category for each PDU session and transmit the corresponding access category, access attempt type, etc. to the AS layer.

In process 665, the AS layer operates as follows.

Based on the access category information, access baring factor, and access baring time received and stored in process 601, the AS layer performs access barring for the access category corresponding to barring, and access skip for the access category corresponding to barring skip. In order to determine whether to perform access barring or access barring skip, the AS layer refers to the access attempt received from the NAS layer and the mapping information of the access category. In other words, if the access category transmitted by the NAS layer to the AS layer corresponds to access barring, the access is barred, and if the category corresponds to access barring skip, the access barring skip is performed.

According to an embodiment, the AS of the UE derives a rand which is a random value between 0 and 1, and if the derived random value is less than the received barring factor, the access is not prohibited, and if the derived random value is greater than the barring factor, the access is considered prohibited. If the access is prohibited, the UE derives an actual barring time (derived actual barring timer: derived barring time) using the received barring time and random value, and delays the access attempt during the derived barring timer. If the access is prohibited, the AS of the UE notifies the NAS that the access is prohibited, and when the derived barring timer expires, the AS may notify the NAS that “the NAS may request the AS to attempt access again”.

In this case, as assumed above, if the PDU session is a multiple PDU session, the following problems may occur. For example, as explained above, when assuming that PDU session 2 is an always-on PDU session and operator-defined access category 32, access may be barred by the operator-defined access category 32 even though PDU session 2 is the always-on PDU session. On the other hand, PDU session 1 and PDU session 3 may belong to the standard access category and access may be allowed.

According to the prior art, in process 665, access is barred by PDU session 2 out of 3 PDU sessions, so the RRC reconfiguration/configuration/resume/connection setup complete messages cannot be transmitted from the UE 101 to the 5G RAN 103, and the PDU session establishment/modification request message in process 671 cannot be transmitted either.

In process 665, the UE 101 operates as follows.

The AS layer may determine whether to bar/allow access of the UE 101 for a corresponding cell, based on access category information related to access class barring and access class barring skip, information such as barring factor, barring timer, etc. received through SIB1 and stored in the UE 101, access attempt type information and access category information received from the NAS layer, and mapping information.

In this process, when there is a PDU session including the operator-defined access category, the AS layer may determine whether to bar access for each PDU session other than the PDU session including the operator-defined access category. In this case, the AS layer may determine whether to bar each PDU session based on access category information related to access barring and access barring skip, information such as barring factor, barring timer, etc. received through SIB1 and stored in the UE 101, access attempt type information and access category information received from the NAS layer, and mapping information, data network name (DNN) related to each PDU session, network slice information related to each PDU session such as network slice selection assistance information (S-NSSAI) (network slice identifier), etc.

For example, if the access class baring (ACB) values received by the UE through SIB1 are 32 and 4, if PDU session 2 is the always-on PDU session, and if access category 7 is mapped to PDU session 1, operator-defined access category 32 is mapped to PDU session 2, and access category 3 is mapped to PDU session 3 in the NAS layer, PDU session 2 with access attempt type 32 is barred in the AS layer, but PDU session 1 with access category 7 and PDU session 3 with access category 3 are not barred, and access of the UE 101 to the corresponding cell is allowed.

In an embodiment, access categories 10 to 31 are currently reserved for use as new standard access categories. Therefore, values from access categories 10 to 31 may be used, and these values may be assigned to the access categories.

For example, if the access class baring (ACB) values received by the UE through SIB1 are 32 and 4, if PDU session 2 is the always-on PDU session, and if access category 7 is mapped to PDU session 1, operator-defined access category 32 is mapped to PDU session 2, and access category 3 is mapped to PDU session 3 in the NAS layer, PDU session 2 with access attempt type 32 is barred in the AS layer, but one of the new access categories 10 to 31 may be assigned to multiple PDU sessions other than the operator default access category such as PDU session 1 with access category 7 and PDU session 3 with access category 3. Accordingly, access to PDU session 1 and PDU session 3 is not barred, and access to the corresponding cell is allowed for the UE 101.

Thereafter, the UE 101 may transmit an RRC reconfiguration/reset/resume/connection setup complete message to a gNB (e.g., 5G NR).

In process 653, the NAS layer of the UE 101 may transmit a service request message to the AMF 111. When transmitting the service request message, the UE 101 may transmit a bit indicating the PDU session as 1 (on state) to the uplink status IE of the always-on PDU session.

In subsequent process 655, in response to the service request message, the service accept message may be transmitted from the AMF 111 to the UE 101.

In process 671, a PDU session establishment request or PDU session modification request message may be transmitted from the UE 101 to the SMF 121.

The PDU session establishment request/PDU session modification request must meet the following conditions.

### Embodiment 3

If the access attempt is for an existing PDU session i.e. it is triggered by:
a request from upper layers to send an UL NAS TRANSPORT message for the purpose of PDU session modification unless the request triggered a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session modification;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session release;
a service request procedure (or a registration procedure if the UE is in state 5GMM-REGISTERED.ATTEMPTING-REGISTRATION-UPDATE) requesting user-plane resources for a PDU session
an uplink user data packet is to be sent for a PDU session with suspended user-plane resources;
and/or
any of PDU sessions in the PDU SESSION ESTABLISHMENT ACCEPT message is not always-on PDU session ; or
if any of PDU sessions in the PDU SESSION ESTABLISHMENT ACCEPT message is always-on PDU session and the user-plane resources for these PDU sessions are established

(If the access attempt is for an existing PDU session i.e. it is triggered by:
a request from upper layers to send an UL NAS TRANSPORT message for the purpose of PDU session modification unless the request triggered a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session modification;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session release;
a service request procedure (or a registration procedure if the UE is in state 5GMM-REGISTERED.ATTEMPTING-REGISTRATION-UPDATE) requesting user-plane resources for a PDU session
an uplink user data packet is to be sent for a PDU session with suspended user-plane resources;
And/or
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established)
(and/or
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established)
then:
the access attempt matches access category criteria type DNN if the DNN provided by the network in the PDU SESSION ESTABLISHMENT ACCEPT message matches any of the access criteria type values associated with the access criteria type DNN; and
the access attempt matches access category criteria type S-NSSAI if the S-NSSAI associated with the PDU session matches any of the access criteria type values associated with the access criteria type S-NSSAI.
(then:
the access attempt matches access category criteria type DNN if the DNN provided by the network in the PDU SESSION ESTABLISHMENT ACCEPT message matches any of the access criteria type values associated with the access criteria type DNN; and
the access attempt matches access category criteria type S-NSSAI if the S-NSSAI associated with the PDU session matches any of the access criteria type values associated with the access criteria type S-NSSAI.)

### Embodiment 4

If the access attempt is to establish a new PDU session i.e. it is triggered by:
a request from upper layers to send an UL NAS TRANSPORT message for the purpose of PDU session establishment unless the request triggered a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session establishment;
(and/or
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established)
then:
the access attempt matches access category criteria type DNN if the DNN requested by the UE during the PDU session establishment procedure matches any of the access criteria type values associated with the access criteria type DNN; and
the access attempt matches access category criteria type S-NSSAI if the S-NSSAI requested by the UE during the PDU session establishment procedure matches any of the access criteria type

(If the access attempt is to establish a new PDU session i.e. it is triggered by:
a request from upper layers to send an UL NAS TRANSPORT message for the purpose of PDU session establishment unless the request triggered a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session establishment;
or/and
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established
then:
the access attempt matches access category criteria type DNN if the DNN requested by the UE during the PDU session establishment procedure matches any of the access criteria type values associated with the access criteria type DNN; and
the access attempt matches access category criteria type S-NSSAI if the S-NSSAI requested by the UE during the PDU session establishment procedure matches any of the access criteria type)

In subsequent process 673, a PDU session establishment command or PDU session modification command may be transmitted from the SMF 121 to the UE 101.

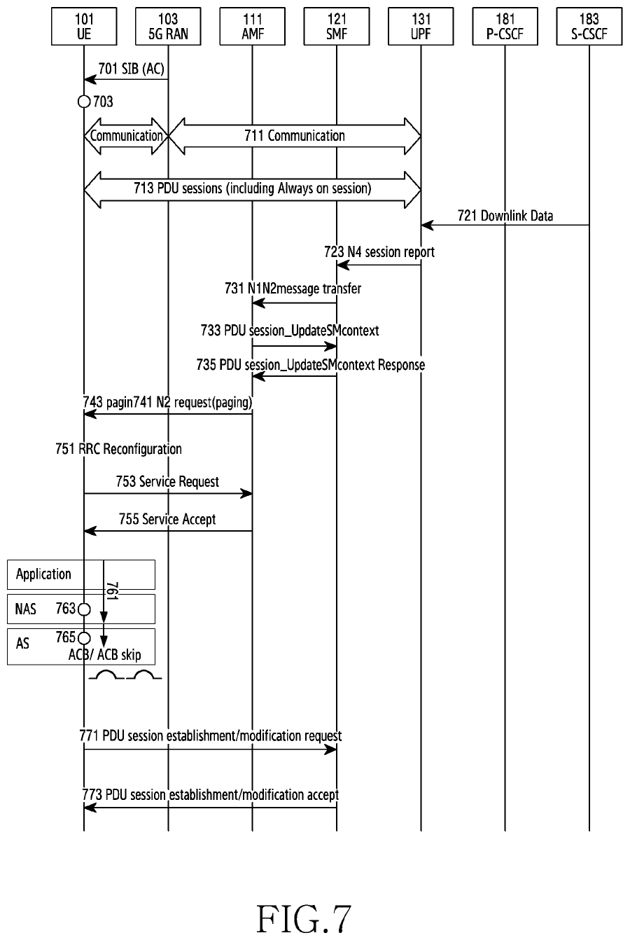

FIG. 7 is a diagram illustrating a procedure for allowing or controlling UE access in a 5G network environment according to an embodiment of the disclosure. FIG. 7 is an embodiment for a case where the UE is in the CM-idle mode state as shown in the process after process 631.

Referring to FIG. 7, in process 701, the UE 101 may receive information on an access category from the 5G RAN 103 gNB. For example, the UE 101 may receive information on the access category from the gNB through broadcast information by using SIB1. Meanwhile, SIB 1 is only an example, and is not limited thereto, and information on the access category may be received through another SIB.

In process 703, the UE 101 may store information on the received access category. In this case, the information on the received access category may include information such as barring factor, access category, and barring time related to the access category. The barring-related information may be explicitly transmitted, or implicitly transmitted as information including a barring factor already defined and an identifier of barring-related information.

In process 711, the UE 101 may communicate with the UPF 131 through the 5G RAN 103.

As illustrated in process 713, in the process in which the UE 101 communicates with the UPF 131 through the 5G RAN 101, multiple PDU sessions may be established and communication may be performed.

Among the PDU sessions, there may be a PDU session belonging to the operator-defined access category. In addition, an always-on PDU session may be included among the PDU sessions. In addition, among the PDU sessions, there may be a PDU session that is the always-on PDU session and belongs to the operator-defined access category. Meanwhile, if a PDU session that is the always-on PDU session and belongs to the operator-defined access category is included among the PDU sessions, the following phenomenon may occur. That is, if the UE 101 changes from an idle mode to a connected mode, if the UE 101 changes from a radio resource control (RRC) inactive mode to an RRC connected mode, or if the RRC connection of the UE 101 is released and changes to a connected mode, access to the network of the UE 101 may be barred.

In process 713, it is assumed that multiple PDU sessions include PDU session 1, PDU session 2, and PDU session 3. Among them, it is assumed that PDU session 2 is the always-on PDU session and the operator-defined access category 32. Meanwhile, the operator-defined access category may be used from 32 to 63, and is a category used when access is to be controlled and/or allowed by each operator.

In process 721, downlink data is transmitted to the UPF from an external DNN or Internet.

In process 723, the UPF transmits an N4 session report message to the SMF to inform that there is downlink data.

In process 731, the SMF transmits an N1N2 message transfer to the AMF. This message includes UPF tunnel endpoint information and QoS-related information.

In subsequent process after process 733, if the UE is in a CM-connected state, the AMF forwards PDU session-related information received from the SMF to the UE.

In process 733, the AMF transmits a PDU session update SM context message to the SMF. The AMF notifies the SMF that the UE wants to establish a user plane connection.

In process 735, the SMF transmits a PDU session update SM context response message to the AMF. This response message transmits information such as UPF tunnel endpoint identifier or UPF tunnel endpoint IP address.

In process 741, the AMF transmits an N2 request message for paging the UE to the 5GRAN.

The AMF stores PDU session information and transmits an N2 request message to request paging to the 5GRAN.

In process 743, the 5GRAN pages the UE. By paging, the UE transmits a service request to the network in the following process.

In process 751, the UE 101 may transmit an RRC reconfiguration/reset/resume/connection setup complete message to a gNB (e.g., 5G NR).

In process 753, the NAS layer of the UE 101 may transmit a service request message to the AMF 111. When transmitting the service request message, the UE 101 may transmit a bit indicating the PDU session as 1 (on state) to the uplink status IE of the always-on PDU session.

In subsequent process 755, in response to the service request message, the service accept message may be transmitted from the AMF 111 to the UE 101.

The service request/accept processes may have the following embodiments and conditions.

### Embodiment 1

For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is not in the range 32 to 63, the UE shall include the Uplink data status IE in the SERVICE REQUEST message and indicate that the UE has pending user data to be sent for those PDU sessions.

(For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is not in the range 32 to 63, the UE shall include the Uplink data status IE in the SERVICE REQUEST message and indicate that the UE has pending user data to be sent for those PDU sessions.)

### Embodiment 2

For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include the Uplink data status IE in the SERVICE REQUEST message and indicate that the UE has not pending user data to be sent for those PDU sessions (by marking 0 for bits pointing to the corresponding PDU sessions).

(For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include the Uplink data status IE in the SERVICE REQUEST message and indicate that the UE has not pending user data to be sent for those PDU sessions (by marking 0 for bits pointing to the corresponding PDU sessions).)

### Embodiment 3

For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include in the SERVICE REQUEST message the Uplink data status IE or the always-on PDU IE which indicates that the UE has not pending user data to be sent for those PDU sessions (by marking 0 for bits pointing to the corresponding PDU sessions) but the UE has always-on PDU sessions (by marking 1 for bits pointing to the corresponding PDU sessions).

(For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include in the SERVICE REQUEST message the Uplink data status IE or the always-on PDU IE which indicates that the UE has not pending user data to be sent for those PDU sessions (by marking 0 for bits pointing to the corresponding PDU sessions) but the UE has always-on PDU sessions (by marking 1 for bits pointing to the corresponding PDU sessions).)

### Embodiment 4

For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include in the SERVICE REQUEST message the Uplink data status IE or the always-on PDU IE indicating that the UE has not pending user data to be sent for those PDU sessions but the UE has always-on PDU sessions.

In other words, the Uplink data status IE in the SERVICE REQUEST message indicates that the UE has not pending user data to be sent for those PDU sessions (by marking 0 for bits pointing to the corresponding PDU sessions).

The always-on PDU IE in the SERVICE REQUEST message indicates that the UE has always-on PDU sessions (by marking 1 for bits pointing to the corresponding PDU sessions).

(For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include in the SERVICE REQUEST message the Uplink data status IE or the always-on PDU IE indicating that the UE has not pending user data to be sent for those PDU sessions but the UE has always-on PDU sessions.

The Uplink data status IE in the SERVICE REQUEST message indicates that the UE has not pending user data to be sent for those PDU sessions (by marking 0 for bits pointing to the corresponding PDU sessions).

The always-on PDU IE in the SERVICE REQUEST message indicates that the UE has always-on PDU sessions (by marking 1 for bits pointing to the corresponding PDU sessions).)

In process 755, the AMF transmits a service accept message to the UE.

Subsequent processes 761, 763, and 765 are processes that occur inside the UE 101.

In process 761, the application layer of the UE 101, for example, the upper layer in charge of the application, may transmit a signal to the NAS layer to trigger the application. Specifically, the initiation of the application layer service may be triggered.

In process 763, the NAS layer of the UE 101 may map the access attempt type and the access category transmitted from the upper layer (e.g., the application layer) and transmit them to the AS layer. Alternatively, the NAS layer of the UE 101 may map the access attempt type and the access category according to the signaling indication transmitted from the upper layer (e.g., the application layer) and transmit the corresponding access category, access attempt type, etc. to the AS layer.

According to an embodiment, the NAS layer may transmit an access category corresponding to an application-related signal, a mobile originate signal, and mobile originate data to the AS layer. In this case, one or more access categories may be selected and transmitted to the AS layer. The access category selected in an embodiment may include a standard category and an operator-defined category. When both the standard category and the operator-defined category are selected, the standard category may be selected or the operator-defined category may be selected with priority over the standard category.

As an embodiment, a service may be mapped to the operator-defined access category and the standard access category. Alternatively, as an embodiment, if a service is not mapped to the operator-defined access category, the service may be mapped to one of the standard access categories.

In process 763, the NAS layer maps the access attempt type information and the access category information based on the service triggered in the application layer, and transfers the mapping information, access attempt type, and access category information to the AS layer. The NAS layer may operate as follows when described using PDU session 1, PDU session 2, and PDU session 3 (PDU sessions used as examples in previous processes).

The NAS layer may map the access attempt type and access category for each PDU session and transmit the corresponding access category, access attempt type, etc. to the AS layer.

In process 765, the AS layer operates as follows.

Based on the access category information, access baring factor, and access baring time received and stored in process 701, the AS layer performs access barring for the access category corresponding to barring, and access skip for the access category corresponding to barring skip. In order to determine whether to perform access barring or access barring skip, the AS layer refers to the access attempt received from the NAS layer and the mapping information of the access category. In other words, if the access category transmitted by the NAS layer to the AS layer corresponds to access barring, the access is barred, and if the category corresponds to access barring skip, the access barring skip is performed.

According to another embodiment, the AS of the UE derives a rand which is a random value between 0 and 1, and if the derived random value is less than the received barring factor, the access is not prohibited, and if the derived random value is greater than the barring factor, the access is considered prohibited. If the access is prohibited, the UE derives an actual barring time (derived actual barring timer: derived barring time) using the received barring time and random value, and delays the access attempt during the derived barring timer. If the access is prohibited, the AS of the UE notifies the NAS that the access is prohibited, and when the derived barring timer expires, the AS may notify the NAS that “the NAS may request the AS to attempt access again”.

In this case, as assumed above, if the PDU session is a multiple PDU session, the following problems may occur. For example, as explained above, when assuming that PDU session 2 is an always-on PDU session and operator-defined access category 32, access may be barred by the operator-defined access category 32 even though PDU session 2 is the always-on PDU session. On the other hand, PDU session 1 and PDU session 3 may belong to the standard access category and access may be allowed.

According to the prior art, in process 765, access is barred by PDU session 2 out of 3 PDU sessions, so the RRC reconfiguration/configuration/resume/connection setup complete messages cannot be transmitted from the UE 101 to the 5G RAN 103, and the PDU session establishment/modification request message in process 771 cannot be transmitted either.

Alternatively, the RRC reconfiguration/configuration/resume/connection setup complete messages cannot be transmitted from the UE 101 to the 5G RAN 103, and the service request message in process 753 cannot be transmitted either.

In process 765, the UE 101 operates as follows.

The AS layer may determine whether to bar/allow access of the UE 101 for a corresponding cell, based on access category information related to access class barring and access class barring skip, information such as barring factor, barring timer, etc. received through SIB1 and stored in the UE 101, access attempt type information and access category information received from the NAS layer, and mapping information.

In this process, when there is a PDU session including the operator-defined access category, the AS layer may determine whether to bar access for each PDU session other than the PDU session including the operator-defined access category. In this case, the AS layer may determine whether to bar each PDU session based on access category information related to access barring and access barring skip, information such as barring factor, barring timer, etc. received through SIB1 and stored in the UE 101, access attempt type information and access category information received from the NAS layer, and mapping information, data network name (DNN) related to each PDU session, network slice information related to each PDU session such as network slice selection assistance information (S-NSSAI) (network slice identifier), etc.

For example, if the access class baring (ACB) values received by the UE through SIB1 are 32 and 4, if PDU session 2 is the always-on PDU session, and if access category 7 is mapped to PDU session 1, operator-defined access category 32 is mapped to PDU session 2, and access category 3 is mapped to PDU session 3 in the NAS layer, PDU session 2 with access attempt type 32 is barred in the AS layer, but PDU session 1 with access category 7 and PDU session 3 with access category 3 are not barred, and access of the UE 101 to the corresponding cell is allowed.

In an embodiment, access categories 10 to 31 are currently reserved for use as new standard access categories. Therefore, values from access categories 10 to 31 may be used, and these values may be assigned to the access categories.

For example, if the access class baring (ACB) values received by the UE through SIB1 are 32 and 4, if PDU session 2 is the always-on PDU session, and if access category 7 is mapped to PDU session 1, operator-defined access category 32 is mapped to PDU session 2, and access category 3 is mapped to PDU session 3 in the NAS layer, PDU session 2 with access attempt type 32 is barred in the AS layer, but one of the new access categories 10 to 31 may be assigned to multiple PDU sessions other than the operator default access category such as PDU session 1 with access category 7 and PDU session 3 with access category 3. Accordingly, access to PDU session 1 and PDU session 3 is not barred, and access to the corresponding cell is allowed for the UE 101.

Thereafter, the UE 101 may transmit an RRC reconfiguration/reset/resume/connection setup complete message to a gNB (e.g., 5G NR).

Through processes such as 761, 763, and 765, the RRC reconfiguration/configuration/resume/connection setup complete messages may be transmitted from the UE 101 to the 5G RAN 103, and PDU session establishment/modification request messages in process 771 may also be transmitted.

Meanwhile, processes such as 761, 763, and 765 may be applied to the UE to transmit an RRC message to the 5G RAN. In that case, the RRC reconfiguration/configuration/resume/connection setup complete messages may be transmitted from the UE 101 to the 5G RAN 103, and the service request message in process 753 may also be transmitted.

In process 771, a PDU session establishment request or PDU session modification request message may be transmitted from the UE 101 to the SMF 121.

In subsequent process 773, a PDU session establishment command or PDU session modification command may be transmitted from the SMF 121 to the UE 101.

The PDU session establishment request/PDU session modification request must meet the following conditions.

### Embodiment 3

If the access attempt is for an existing PDU session i.e. it is triggered by:
a request from upper layers to send an UL NAS TRANSPORT message for the purpose of PDU session modification unless the request triggered a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session modification;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session release;
a service request procedure (or a registration procedure if the UE is in state 5GMM-REGISTERED.ATTEMPTING-REGISTRATION-UPDATE) requesting user-plane resources for a PDU session
an uplink user data packet is to be sent for a PDU session with suspended user-plane resources;
And/or
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established
then:
the access attempt matches access category criteria type DNN if the DNN provided by the network in the PDU SESSION ESTABLISHMENT ACCEPT message matches any of the access criteria type values associated with the access criteria type DNN; and
the access attempt matches access category criteria type S-NSSAI if the S-NSSAI associated with the PDU session matches any of the access criteria type values associated with the access criteria type S-NSSAI.

(If the access attempt is for an existing PDU session i.e. it is triggered by:
a request from upper layers to send an UL NAS TRANSPORT message for the purpose of PDU session modification unless the request triggered a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session modification;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session release;
a service request procedure (or a registration procedure if the UE is in state 5GMM-REGISTERED.ATTEMPTING-REGISTRATION-UPDATE) requesting user-plane resources for a PDU session
an uplink user data packet is to be sent for a PDU session with suspended user-plane resources;
And/or
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established
then:
the access attempt matches access category criteria type DNN if the DNN provided by the network in the PDU SESSION ESTABLISHMENT ACCEPT message matches any of the access criteria type values associated with the access criteria type DNN; and
the access attempt matches access category criteria type S-NSSAI if the S-NSSAI associated with the PDU session matches any of the access criteria type values associated with the access criteria type S-NSSAI.)

### Embodiment 4

If the access attempt is to establish a new PDU session i.e. it is triggered by:
a request from upper layers to send an UL NAS TRANSPORT message for the purpose of PDU session establishment unless the request triggered a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session establishment;
or/and
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established
then,
the access attempt matches access category criteria type DNN if the DNN requested by the UE during the PDU session establishment procedure matches any of the access criteria type values associated with the access criteria type DNN; and
the access attempt matches access category criteria type S-NSSAI if the S-NSSAI requested by the UE during the PDU session establishment procedure matches any of the access criteria type

(If the access attempt is to establish a new PDU session i.e. it is triggered by:
a request from upper layers to send an UL NAS TRANSPORT message for the purpose of PDU session establishment unless the request triggered a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session establishment;
or/and
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established
(and/or
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established)
then:
the access attempt matches access category criteria type DNN if the DNN requested by the UE during the PDU session establishment procedure matches any of the access criteria type values associated with the access criteria type DNN; and
the access attempt matches access category criteria type S-NSSAI if the S-NSSAI requested by the UE during the PDU session establishment procedure matches any of the access criteria type

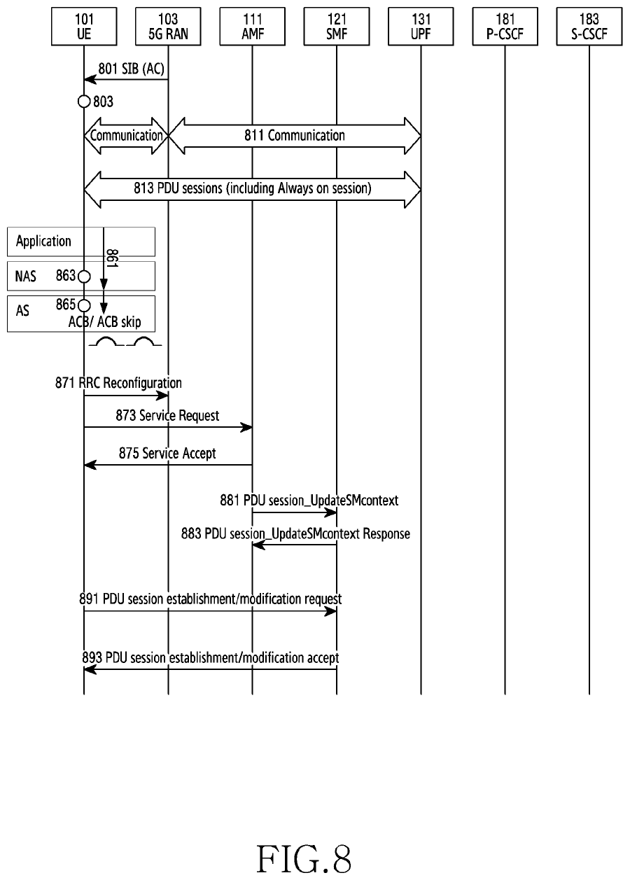

FIG. 8 is a diagram illustrating a procedure for allowing or controlling UE access in a 5G network environment according to an embodiment of the disclosure. FIG. 8 is an embodiment of a case in which the UE is in a CM-connected mode, as may be seen in the processes after process 831.

Referring to FIG. 8, in process 801, the UE 101 may receive information on an access category from the 5G RAN 103 gNB. For example, the UE 101 may receive information on the access category from the gNB through broadcast information by using SIB1. Meanwhile, SIB 1 is only an example, and is not limited thereto, and information on the access category may be received through another SIB.

In process 803, the UE 101 may store information on the received access category. In this case, the information on the received access category may include information such as barring factor, access category, and barring time related to the access category. The barring-related information may be explicitly transmitted, or implicitly transmitted as information including a barring factor already defined and an identifier of barring-related information.

In process 811, the UE 101 may communicate with the UPF 131 through the 5G RAN 103.

As illustrated in process 813, in the process in which the UE 101 communicates with the UPF 131 through the 5G RAN 101, multiple PDU sessions may be established and communication may be performed.

Among the PDU sessions, there may be a PDU session belonging to the operator-defined access category. In addition, an always-on PDU session may be included among the PDU sessions. In addition, among the PDU sessions, there may be a PDU session that is the always-on PDU session and belongs to the operator-defined access category. Meanwhile, if a PDU session that is the always-on PDU session and belongs to the operator-defined access category is included among the PDU sessions, the following phenomenon may occur. That is, if the UE 101 changes from an idle mode to a connected mode, if the UE 101 changes from a radio resource control (RRC) inactive mode to an RRC connected mode, or if the RRC connection of the UE 101 is released and changes to a connected mode, access to the network of the UE 101 may be barred.

In process 813, it is assumed that multiple PDU sessions include PDU session 1, PDU session 2, and PDU session 3. Among them, it is assumed that PDU session 2 is the always-on PDU session and the operator-defined access category 32. Meanwhile, the operator-defined access category may be used from 32 to 63, and is a category used when access is to be controlled and/or allowed by each operator.

Thereafter, for some reason, if the UE 101 changes to an idle mode, if the UE 101 is in an RRC inactive mode, or if the RRC connection of the UE 101 is released, a process is required to change the UE 101 back to the RRC connected state. In this process, there may be a case in which the UE 101's access to the network is barred.

Subsequent processes 861, 863, and 865 are processes that occur inside the UE 101.

In process 861, the application layer of the UE 101, for example, the upper layer in charge of the application, may transmit a signal to the NAS layer to trigger the application. Specifically, the initiation of the application layer service may be triggered.

In process 863, the NAS layer of the UE 101 may map the access attempt type and the access category transmitted from the upper layer (e.g., the application layer) and transmit them to the AS layer. Alternatively, the NAS layer of the UE 101 may map the access attempt type and the access category according to the signaling indication transmitted from the upper layer (e.g., the application layer) and transmit the corresponding access category, access attempt type, etc. to the AS layer.

According to an embodiment, the NAS layer may transmit an access category corresponding to an application-related signal, a mobile originate signal, and mobile originate data to the AS layer. In this case, one or more access categories may be selected and transmitted to the AS layer. The access category selected in an embodiment may include a standard category and an operator-defined category. When both the standard category and the operator-defined category are selected, the standard category may be selected or the operator-defined category may be selected with priority over the standard category.

As an embodiment, a service may be mapped to the operator-defined access category and the standard access category. Alternatively, as an embodiment, if a service is not mapped to the operator-defined access category, the service may be mapped to one of the standard access categories.

In process 863, the NAS layer maps the access attempt type information and the access category information based on the service triggered in the application layer, and transfers the mapping information, access attempt type, and access category information to the AS layer. The NAS layer may operate as follows when described using PDU session 1, PDU session 2, and PDU session 3 (PDU sessions used as examples in process 213).

The NAS layer may map the access attempt type and access category for each PDU session and transmit the corresponding access category, access attempt type, etc. to the AS layer.

In process 865, the AS layer operates as follows.

Based on the access category information, access baring factor, and access baring time received and stored in process 801, the AS layer performs access barring for the access category corresponding to barring, and access skip for the access category corresponding to barring skip. In order to determine whether to perform access barring or access barring skip, the AS layer refers to the access attempt received from the NAS layer and the mapping information of the access category. In other words, if the access category transmitted by the NAS layer to the AS layer corresponds to access barring, the access is barred, and if the category corresponds to access barring skip, the access barring skip is performed.

According to another embodiment, the AS of the UE derives a rand which is a random value between 0 and 1, and if the derived random value is less than the received barring factor, the access is not prohibited, and if the derived random value is greater than the barring factor, the access is considered prohibited. If the access is prohibited, the UE derives an actual barring time (derived actual barring timer: derived barring time) using the received barring time and random value, and delays the access attempt during the derived barring timer. If the access is prohibited, the AS of the UE notifies the NAS that the access is prohibited, and when the derived barring timer expires, the AS may notify the NAS that “the NAS may request the AS to attempt access again”.

In this case, as assumed above, if the PDU session is a multiple PDU session, the following problems may occur. For example, as explained above, when assuming that PDU session 2 is an always-on PDU session and operator-defined access category 32, access may be barred by the operator-defined access category 32 even though PDU session 2 is the always-on PDU session. On the other hand, PDU session 1 and PDU session 3 may belong to the standard access category and access may be allowed.

According to the prior art, in process 865, access is barred by PDU session 2 out of 3 PDU sessions, so the RRC reconfiguration/configuration/resume/connection setup complete messages cannot be transmitted from the UE 101 to the 5G RAN 103, and the PDU session establishment/modification request message in process 891 cannot be transmitted either.

Alternatively, the RRC reconfiguration/configuration/resume/connection setup complete messages cannot be transmitted from the UE 101 to the 5G RAN 103, and the service request message in process 873 cannot be transmitted either.

In process 865, the UE 101 operates as follows.

The AS layer may determine whether to bar/allow access of the UE 101 for a corresponding cell, based on access category information related to access class barring and access class barring skip, information such as barring factor, barring timer, etc. received through SIB1 and stored in the UE 101, access attempt type information and access category information received from the NAS layer, and mapping information.

In this process, when there is a PDU session including the operator-defined access category, the AS layer may determine whether to bar access for each PDU session other than the PDU session including the operator-defined access category. In this case, the AS layer may determine whether to bar each PDU session based on access category information related to access barring and access barring skip, information such as barring factor, barring timer, etc. received through SIB1 and stored in the UE 101, access attempt type information and access category information received from the NAS layer, and mapping information, data network name (DNN) related to each PDU session, network slice information related to each PDU session such as network slice selection assistance information (S-NSSAI) (network slice identifier), etc.

For example, if the access class baring (ACB) values received by the UE through SIB1 are 32 and 4, if PDU session 2 is the always-on PDU session, and if access category 7 is mapped to PDU session 1, operator-defined access category 32 is mapped to PDU session 2, and access category 3 is mapped to PDU session 3 in the NAS layer, PDU session 2 with access attempt type 32 is barred in the AS layer, but PDU session 1 with access category 7 and PDU session 3 with access category 3 are not barred, and access of the UE 101 to the corresponding cell is allowed.

In an embodiment, access categories 10 to 31 are currently reserved for use as new standard access categories. Therefore, values from access categories 10 to 31 may be used, and these values may be assigned to the access categories.

For example, if the access class baring (ACB) values received by the UE through SIB1 are 32 and 4, if PDU session 2 is the always-on PDU session, and if access category 7 is mapped to PDU session 1, operator-defined access category 32 is mapped to PDU session 2, and access category 3 is mapped to PDU session 3 in the NAS layer, PDU session 2 with access attempt type 32 is barred in the AS layer, but one of the new access categories 10 to 31 may be assigned to multiple PDU sessions other than the operator default access category such as PDU session 1 with access category 7 and PDU session 3 with access category 3. Accordingly, access to PDU session 1 and PDU session 3 is not barred, and access to the corresponding cell is allowed for the UE 101.

In subsequent process 871, the UE 101 may transmit an RRC reconfiguration/reset/resume/connection setup complete message to a gNB (e.g., 5G NR).

In process 873, the NAS layer of the UE 101 may transmit a service request message to the AMF 111. When transmitting the service request message, the UE 101 may transmit a bit indicating the PDU session as 1 (on state) to the uplink status IE of the always-on PDU session.

In subsequent process 875, in response to the service request message, the service accept message may be transmitted from the AMF 111 to the UE 101.

The service request/accept processes may have the following embodiments and conditions.

### Embodiment 1

For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is not in the range 32 to 63, the UE shall include the Uplink data status IE in the SERVICE REQUEST message and indicate that the UE has pending user data to be sent for those PDU sessions.

(For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is not in the range 32 to 63, the UE shall include the Uplink data status IE in the SERVICE REQUEST message and indicate that the UE has pending user data to be sent for those PDU sessions.)

### Embodiment 2

For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include the Uplink data status IE in the SERVICE REQUEST message and indicate that the UE has not pending user data to be sent for those PDU sessions (by marking 0 for bits pointing to the corresponding PDU sessions).

For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include the Uplink data status IE in the SERVICE REQUEST message and indicate that the UE has not pending user data to be sent for those PDU sessions (by marking 0 for bits pointing to the corresponding PDU sessions).

### Embodiment 3

For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include in the SERVICE REQUEST message the Uplink data status IE or the always-on PDU IE which indicates that the UE has not pending user data to be sent for those PDU sessions (by marking 0 for bits pointing to the corresponding PDU sessions) but the UE has always-on PDU sessions (by marking 1 for bits pointing to the corresponding PDU sessions).

(For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include in the SERVICE REQUEST message the Uplink data status IE or the always-on PDU IE which indicates that the UE has not pending user data to be sent for those PDU sessions (by marking 0 for bits pointing to the corresponding PDU sessions) but the UE has always-on PDU sessions (by marking 1 for bits pointing to the corresponding PDU sessions).)

### Embodiment 4

For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include in the SERVICE REQUEST message the Uplink data status IE or the always-on PDU IE indicating that the UE has not pending user data to be sent for those PDU sessions but the UE has always-on PDU sessions.

The Uplink data status IE in the SERVICE REQUEST message indicates that the UE has not pending user data to be sent for those PDU sessions (by marking 0 for bits pointing to the corresponding PDU sessions).

The always-on PDU IE in the SERVICE REQUEST message indicates that the UE has always-on PDU sessions (by marking 1 for bits pointing to the corresponding PDU sessions).

(For all cases except cases o) and p) in subclause 5.6.1.1, if the UE has one or more active always-on PDU sessions associated with the access type over which the SERVICE REQUEST message is sent and the user-plane resources for these PDU sessions are not established, and the access category applicable for the access attempt is in the range 32 to 63, the UE shall include in the SERVICE REQUEST message the Uplink data status IE or the always-on PDU IE indicating that the UE has not pending user data to be sent for those PDU sessions but the UE has always-on PDU sessions.

The Uplink data status IE in the SERVICE REQUEST message indicates that the UE has not pending user data to be sent for those PDU sessions (by marking 0 for bits pointing to the corresponding PDU sessions).

The always-on PDU IE in the SERVICE REQUEST message indicates that the UE has always-on PDU sessions (by marking 1 for bits pointing to the corresponding PDU sessions).)

In process 881, the AMF transmits a PDU session update SM context message to the SMF. The AMF notifies the SMF that the UE wants to establish a user plane connection.

In process 883, the SMF transmits a PDU session update SM context response message to the AMF. This response message transmits information such as UPF tunnel endpoint identifier or UPF tunnel endpoint IP address.

In process 891, a PDU session establishment request or PDU session modification request message may be transmitted from the UE 101 to the SMF 121.

In subsequent process 893, a PDU session establishment command or PDU session modification command may be transmitted from the SMF 121 to the UE 101.

The PDU session establishment request/PDU session modification request must meet the following conditions.

### Embodiment 3

If the access attempt is for an existing PDU session i.e. it is triggered by:
a request from upper layers to send an UL NAS TRANSPORT message for the purpose of PDU session modification unless the request triggered a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session modification;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session release;
a service request procedure (or a registration procedure if the UE is in state 5GMM-REGISTERED.ATTEMPTING-REGISTRATION-UPDATE) requesting user-plane resources for a PDU session
an uplink user data packet is to be sent for a PDU session with suspended user-plane resources;
And/or
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established
then:
the access attempt matches access category criteria type DNN if the DNN provided by the network in the PDU SESSION ESTABLISHMENT ACCEPT message matches any of the access criteria type values associated with the access criteria type DNN; and
the access attempt matches access category criteria type S-NSSAI if the S-NSSAI associated with the PDU session matches any of the access criteria type values associated with the access criteria type S-NSSAI.

(If the access attempt is for an existing PDU session i.e. it is triggered by:
a request from upper layers to send an UL NAS TRANSPORT message for the purpose of PDU session modification unless the request triggered a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session modification;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session release;
a service request procedure (or a registration procedure if the UE is in state 5GMM-REGISTERED.ATTEMPTING-REGISTRATION-UPDATE) requesting user-plane resources for a PDU session
an uplink user data packet is to be sent for a PDU session with suspended user-plane resources;
And/or
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established
(And/or
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established)
then:
the access attempt matches access category criteria type DNN if the DNN provided by the network in the PDU SESSION ESTABLISHMENT ACCEPT message matches any of the access criteria type values associated with the access criteria type DNN; and
the access attempt matches access category criteria type S-NSSAI if the S-NSSAI associated with the PDU session matches any of the access criteria type values associated with the access criteria type S-NSSAI.)

### Embodiment 4

If the access attempt is to establish a new PDU session i.e. it is triggered by:
a request from upper layers to send an UL NAS TRANSPORT message for the purpose of PDU session establishment unless the request triggered a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session establishment;
or/and
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established
(and/or
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established)
then:
the access attempt matches access category criteria type DNN if the DNN requested by the UE during the PDU session establishment procedure matches any of the access criteria type values associated with the access criteria type DNN; and
the access attempt matches access category criteria type S-NSSAI if the S-NSSAI requested by the UE during the PDU session establishment procedure matches any of the access criteria type

(If the access attempt is to establish a new PDU session i.e. it is triggered by:
a request from upper layers to send an UL NAS TRANSPORT message for the purpose of PDU session establishment unless the request triggered a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode;
a service request procedure (or a registration procedure if the UE is in state 5GMM-REGISTERED.ATTEMPTING-REGISTRATION-UPDATE) to transition the UE from 5GMM-IDLE mode or 5GMM-IDLE mode with suspend indication to 5GMM-CONNECTED mode triggered by a request from upper layers to send an UL NAS TRANSPORT message for the purpose of PDU session establishment;
or/and
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established
(and/or
any of PDU sessions in the PDU SESSION ESTABLISHMENT ACCEPT message is not always-on PDU session; or
if any of PDU sessions in the PDU SESSION ESTABLISHMENT ACCEPT message is always-on PDU session and the user-plane resources for these PDU sessions are established)
then:
the access attempt matches access category criteria type DNN if the DNN requested by the UE during the PDU session establishment procedure matches any of the access criteria type values associated with the access criteria type DNN; and
the access attempt matches access category criteria type S-NSSAI if the S-NSSAI requested by the UE during the PDU session establishment procedure matches any of the access criteria type)

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

In methods of the disclosure, some or all of the contents of each embodiment may be implemented in combination without departing from the essential spirit and scope of the disclosure.

In the drawings in which methods of the disclosure are described, the order of the description does not always correspond to the order in which steps are performed, and the order relationship between the steps may be changed or the steps may be performed in parallel. Alternatively, in the drawings in which methods of the disclosure are described, some elements may be omitted and only some elements may be included therein without departing from the essential spirit and scope of the disclosure. Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

1. A method of operating a terminal in a mobile communication system, the method comprising:
receiving, from a base station, information on an access category including an operator-defined access category via a system information block (SIB); and
determining whether access is barred for each protocol data unit (PDU) session from among a plurality of PDU sessions including a PDU session corresponding to the operator-defined access category, based on the information on the access category.

2. The method of claim 1,
wherein the determining of whether access is barred for each PDU session comprises:
barring access to the PDU session corresponding to the operator-defined access category in case that the PDU session corresponding to the operator-defined access category corresponds to an always-on PDU session; and
determining whether access is barred for each PDU session for at least one PDU session excluding the PDU session corresponding to the operator-defined access category from among the plurality of PDU sessions.

3. The method of claim 1,
wherein the determining of whether access is barred for each PDU session comprises:
barring access to the PDU session corresponding to the operator-defined access category in case that the PDU session corresponding to the operator-defined access category corresponds to a PDU session accessing a preconfigured network slice; and
determining whether access is barred for each PDU session for at least one PDU session excluding the PDU session corresponding to the operator-defined access category from among the plurality of PDU sessions.

4. The method of claim 1,
wherein the information on the access category further includes information on a reserved access category, and
wherein the method further comprises granting a reserved access category and allowing access for at least one PDU session excluding the PDU session corresponding to the operator-defined access category from among the plurality of PDU sessions.

5. A method of operating a base station in a mobile communication system, the method comprising:
determining information on an access category including an operator-defined access category;
transmitting, to a terminal, the information on the access category via a system information block (SIB); and
determining whether access is barred for each PDU session from among a plurality of PDU sessions including a protocol data unit (PDU) session corresponding to the operator-defined access category, based on the information on the access category.

6. The method of claim 5, further comprising transmitting, to the terminal, a PDU session establishment accept message indicating an always-on PDU session,
wherein the determining whether access is barred for each PDU session comprises:
barring access to the PDU session corresponding to the operator-defined access category in case that the PDU session corresponding to the operator-defined access category corresponds to the always-on PDU session; and
determining whether access is barred for each PDU session for at least one PDU session excluding the PDU session corresponding to the operator-defined access category from among the plurality of PDU sessions.

7. The method of claim 5, further comprising transmitting, to the terminal, a PDU session establishment accept message indicating network slice information including an identifier of a preconfigured network slice,
wherein the determining whether access is barred for each PDU session comprises:
barring access to the PDU session corresponding to the operator-defined access category in case that the PDU session corresponding to the operator-defined access category accesses the preconfigured network slice; and
determining whether access is barred for each PDU session for at least one PDU session excluding the PDU session corresponding to the operator-defined access category from among the plurality of PDU sessions.

8. A terminal in a mobile communication system comprising:
a transceiver;
a memory; and
at least one processor connected to the transceiver and the memory,
wherein the at least one processor is controlled to:
receive, from a base station, information on an access category including an operator-defined access category via a system information block (SIB); and
determine whether access is barred for each PDU session from among a plurality of PDU sessions including a protocol data unit (PDU) session corresponding to the operator-defined access category, based on the information on the access category.

9. The terminal of claim 8,
wherein the at least one processor is controlled to:
bar access to the PDU session corresponding to the operator-defined access category in case that the PDU session corresponding to the operator-defined access category corresponds to an always-on PDU session; and
determine whether access is barred for each PDU session for at least one PDU session excluding the PDU session corresponding to the operator-defined access category from among the plurality of PDU sessions.

10. The terminal of claim 8,
wherein the at least one processor is controlled to:
bar access to the PDU session corresponding to the operator-defined access category in case that the PDU session corresponding to the operator-defined access category corresponds to a PDU session accessing a preconfigured network slice; and
determine whether access is barred for each PDU session for at least one PDU session excluding the PDU session corresponding to the operator-defined access category from among the plurality of PDU sessions.

11. The terminal of claim 8,
wherein the information on the access category further includes information on a reserved access category; and
wherein the at least one processor is further controlled to grant a reserved access category and allow access for at least one PDU session excluding the PDU session corresponding to the operator-defined access category from among the plurality of PDU sessions.

12. A base station in a mobile communication system comprising:
a transceiver;
a memory; and
at least one processor connected to the transceiver and the memory,
wherein the at least one processor is controlled to:
determine information on an access category including an operator-defined access category;
transmit, to a terminal, the information on the access category via a system information block (SIB); and
determine whether access is barred for each PDU session from among a plurality of PDU sessions including a protocol data unit (PDU) session corresponding to the operator-defined access category, based on the information on the access category.

13. The base station of claim 12,
wherein the at least one processor is further controlled to:
transmit, to the terminal, a PDU session establishment accept message indicating an always-on PDU session;
bar access to the PDU session corresponding to the operator-defined access category in case that the PDU session corresponding to the operator-defined access category corresponds to the always-on PDU session; and
determine whether access is barred for each PDU session for at least one PDU session excluding the PDU session corresponding to the operator-defined access category from among the plurality of PDU sessions.

14. The base station of claim 12,
wherein the at least one processor is further controlled to:
transmit, to the terminal, a PDU session establishment accept message indicating network slice information including an identifier of a preconfigured network slice;
bar access to the PDU session corresponding to the operator-defined access category in case that the PDU session corresponding to the operator-defined access category accesses the preconfigured network slice; and
determine whether access is barred for each PDU session for at least one PDU session excluding the PDU session corresponding to the operator-defined access category from among the plurality of PDU sessions.

15. The base station of claim 12,
wherein the information on the access category further includes information on a reserved access category, and
wherein the at least one processor is further controlled to grant a reserved access category and allow access for at least one PDU session excluding the PDU session corresponding to the operator-defined access category from among the plurality of PDU sessions.
